(19) United States
(12) Patent Application Publication
(10) Pub. No.: US 2019/0159478 A1
(43) Pub. Date: May 30, 2019

(54) PROCESSES FOR PRODUCING ANIMAL FEED FROM PEANUT FEEDSTOCKS

(71) Applicant: Archer Daniels Midland Company, Decatur, IL (US)

(72) Inventor: Michael J Cecava, Monticello, IL (US)

(73) Assignee: Archer Daniels Midland Company

(21) Appl. No.: 16/206,299

(22) Filed: Nov. 30, 2018

Related U.S. Application Data
(60) Provisional application No. 62/592,508, filed on Nov. 30, 2017.

(51) Int. Cl. A23K 10/30; A23K 20/22; A23K 30/20; A23K 40/10

(52) U.S. Cl. CPC A23K 10/30; A23K 40/10; A23K 30/20; A23K 20/22

(57) ABSTRACT

A method of producing animal food pellets wherein solid and liquid ingredients of the food are premixed and the resulting mash is extruded in a ring die pellet extruder without steam conditioning and the extruded pellets are cooled and/or dried as may be required. The premixed ingredients will have cohesive properties so that additional pelleting binding agents are not required to form a densified pellet. The resulting product will be a nourishing food that substitutes grain and other ingredients in the diet of animals.

### CROSS-REFERENCE TO RELATED APPLICATIONS

This application claims priority to U.S. Provisional Patent Application 62/592,508, filed Nov. 30, 2017, the contents of the entirety of which is incorporated by this reference.

### TECHNICAL FIELD

The present invention relates to animal feeds. More specifically, the present invention relates to methods of compressing liquid-solid mixtures of feedstocks derived from peanuts to form food products for animals.

### BACKGROUND OF THE INVENTION

Peanut by-products supply substantial quantities of feedstuffs to animals grown in the same region where peanuts are produced. Peanut processing coproducts are generally priced below other by-products and they can be incorporated into a variety of diets primarily fed to ruminant livestock, including cow herds, growing-finishing cattle, and dairy cattle. Included in the list of products fed to animals are whole peanuts and peanut meal, peanut skins, peanut hull fiber, peanut soapstocks, peanut hay, and silages. Peanut hull fibers are often used as low value roughage in ruminant foods and are fed at modest levels, e.g., up to 20% of beef cattle diets. They also are used as bedding in animal pens because of their absorptive properties.

Peanut shells in particular have certain limitations when used as animal feedstock. They are bulky and difficult to handle, and possess poor flow properties. Their low bulk density limits practical use to livestock operations that are in proximity to shelling plants. Peanut shells also are high in fiber and low in protein which potentially limits their utility as a nutritious foodstuff for animals.

Peanut soapstock is an energy-rich coproduct originating from the processing of peanuts to produce food grade peanut oil. The raw soapstock is difficult to handle because of its poor flow properties unless heated and its high water content. It also is unstable and becomes rancid quickly, thus limiting its usefulness as a palatable ingredient.

Thus, a need exists to find ways to form products from peanut processing streams that can substitute for grains and other ingredients in animal food. A need also exists to improve the handling properties and stability of peanut streams so that they can be transported and stored before feeding to animals.

### SUMMARY OF THE INVENTION

In each of its various embodiments, the present invention fulfills these needs and discloses processes for forming animal feeds from peanut byproducts.

In an embodiment, a method of making ready-to-consume animal feed pellets without using steam conditioning or pellet binder comprises forming a uniform mixture of a solid peanut ingredient and a liquid peanut ingredient and passing the uniform mixture through a pellet mill having a roller and die extruder, thus forming pellets. The method does not subject the uniform mixture to steam conditioning.

The method may also include cooling the pellets and/or drying the pellets. The liquid peanut ingredient may have viscous and cohesive properties. The liquid peanut ingredient and the solid peanut ingredient includes at least one labile feed ingredient. The temperature of the pellet in the pellet mill may not exceed 150 degrees F.

The method may also include removing fine particles from the pellets and/or mixing the fine particles with the uniform mixture. The solid peanut ingredient may be peanut meal, peanut hulls, and a combination thereof, and the liquid peanut ingredient may be peanut soapstock.

In one embodiment, a method of producing a pellet comprises mixing a liquid peanut coproduct with a solid peanut coproduct, thus producing a mixture and compressing the mixture, thus producing a pellet. The liquid peanut coproduct may be peanut soapstock present in the pellet at an amount of 1-10% by weight, 3-8% by weight, or 5-7% by weight. The solid peanut coproduct may be peanut meal, peanut hulls, and a combination thereof.

The method may also include mixing a pelleting agent and/or an acidifier with the mixture. The acidifier may be present in such an amount to stabilize the pellet and may be sodium propionate. The method may further include removing fine particles from the pellets and/or mixing the fine particles with the uniform mixture.

Animal food pellets made according to the methods of present invention are further disclosed.

### BRIEF DESCRIPTION OF THE DRAWINGS

FIG. 1 shows the dry feed intake by cattle offered an embodiment of animal feed pellets of the present invention.

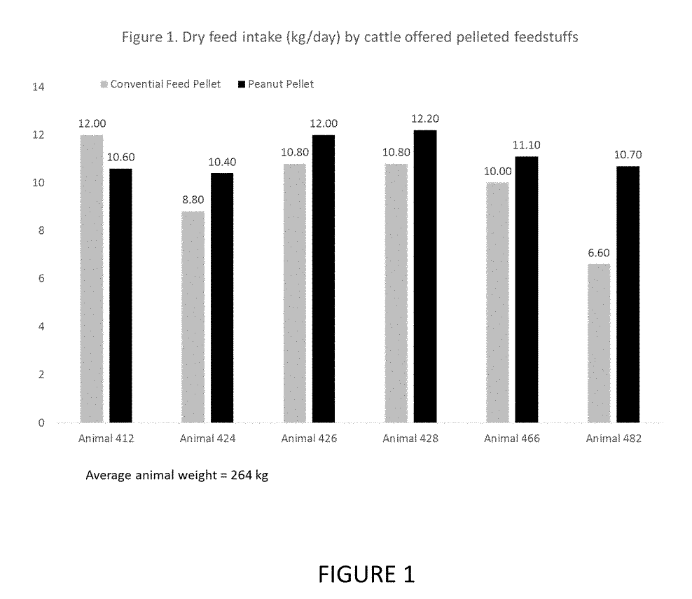

### DETAILED DESCRIPTION

Pelleting was introduced into the United States feed industry in the mid-1920's to improve feed utilization, increase the density of the feed and improve handling characteristics. Prior to about 1930 several different types of pelleting machines were utilized. Toward the end of the 1920's the so-called “flat die” pelleting machine and “ring die” pellet mill were developed in some of their prior forms. While the flat die machine is still in use in certain applications, the ring die pellet mill quickly became the preferred design and was quickly adopted by the animal teed industry and remains the form of pelleting machine of choice today. In addition to the ring die pellet mill itself, auxiliary equipment was developed including conditioners, cooler/dryers, and related process equipment.

The early pelleting process involved mixing the feed ingredients and pelleting them with no further treatment. The rationale for this approach was to prevent alterations to vitamins and proteins due to the addition of heat to the feed mix. In the late 1930's some processors began subjecting pellet-forming mixtures of animal feed to water and steam by passing the mixtures through a conditioner prior to introduction into the pellet extruders. The addition of steam improved production rates, reduced die wear, and improved pellet quality. Steam conditioning was quickly adopted by the industry and has remained an integral part of the pelleting process to the present time.

In the conditioning step, live steam is injected into the feed mash as it is conveyed through the conditioner which generally consists of a cylindrical tube with a rotating shaft upon which numerous paddles or picks are mounted. The condensing steam increases the temperature and moisture content of the mash. Since the steam is injected directly into the feed mash, the boiler treatment chemicals must be FDA approved.

The focus on research into the pelleting process since the 1960's has been on improving the conditioning operation, with emphasis on increasing the retention time and increasing the temperature to which the mash is conditioned. One of the more recent developments was a pressure pelleting system in which the conditioner and pelleting die cavities were pressurized. This allowed use of higher temperatures and longer conditioning times to improve pellet durability and increase the production rate. However, the use of increased temperatures and conditioning times militates against the inclusion of heat sensitive or labile ingredients which are desirable in complete animal feeds.

The limitations of using peanut coproducts as foodstuffs for animals has been overcome in the present invention as the peanut coproducts are combined and compacted to form stable and flowable food products. Peanut meal is used a complementary protein-rich ingredient for inclusion in a mixture. Peanut soapstocks left over from peanut oil processing is used a complementary energy-rich component of a mixture. A combination of such ingredients is mixed with highly absorptive peanut shell fiber and compressed to form a densified and uniform material that is stable and transportable. Such products are used to substitute more expensive ingredients fed to animals, such as grain, oilseed meals, and hays and forages.

In an embodiment, the present invention departs materially from the current pelleting processes by eliminating the use of a pelleting agent and eliminating the conventional conditioning step involving the use of steam and elevated temperatures. In comparison with the conventional pelleting processes, the binders are feed ingredients in themselves and have viscous and cohesive properties. When the liquid is applied to the other feed ingredients, free moisture from the liquid penetrates solid particles in the meal while the viscous cohesive substances in the liquid agglomerate fine particles into larger particles and then remain on the surfaces of the large solid particles, creating a cohesive surface. When the resulting moist cohesive mash is compressed through the die, the particles are compacted and bound together to form pellets having enhanced durability with a substantial reduction in fines.

The batching, mixing and pelleting steps of the present invention can be carried out using commercial equipment currently used in the conventional pelleting process. This equipment may he combined in an installation having a mixer which discharges into a surge bin, which in turn discharges into a pellet mill having a variable-speed feeder, a steam conditioning chamber, and/or a die/roller assembly. Feed mash flows from the feeder through the conditioner, which discharges into the die/roller assembly where the feed is extruded to form pellets. The pellets are discharged from the pellet roll. In the present invention, the steam conditioning chamber is optional to the process.

As in pelleting, the drying/cooling step may also be carried out in conventional commercial equipment such as a horizontal belt cooler in which the feed pellets are conveyed onto a moving belt through which air is drawn to cool and dry the product. Depending on the fines content of the pellets after drying/cooling, the pellets may he screened to remove the fines that result as the pellets are cut at the die and that are generated in the subsequent handling during the drying/cooling process. For some feeds, the fines level may be as high as five to ten percent, or more. These fines are recycled back to the surge bin where they are fed back into the process along with the unpelleted mash.

After batching, the dry ingredients are mixed in the mixer. Then the liquid ingredients, such as fat and molasses, are added and mixed. In conventional pelleting, a liquid binder is added last by blending the binder into the mix to obtain a uniform cohesive mash. Liquid binders can be used at a rate of 5 to 25% by weight in a formula, with 10 to 20% being preferred. Liquid feed ingredients are usually relatively economical nutrient sources being condensed liquid by-products from the grain, food or feed processing industries. The most commonly used liquid ingredients in the conventional pelleting process are molasses and fat. The amount of those liquids is usually restricted to less than 6% in a conventional pelleting process.

In a pelleting processes, meal conditioning with steam may be used for the compression of the meal or mash into pellets. Heat and water from the steam serve to activate binders in the meal particles (i.e. protein and carbohydrates), soften them and bring cohesive properties onto the surfaces of the particles. When the mash is compressed through a die, the particles are compacted and stuck together to form pellets. In the cold pelleting process of the present invention, liquid binders are used instead of steam. The binders have viscous and cohesive properties. When such a liquid binder is applied, free moisture penetrates solid particles in the mash while the viscous, cohesive substances in the binder agglomerate fine particles into larger particles and then remain on the surfaces of large solid particles, creating cohesive surfaces. When the moist, cohesive mash is compressed through a die, the particles are compacted and bound together to form durable pellets.

Liquid binders that may be used include Brewex (a concentrated molasses-like by-product of the brewing industry), com steep liquor, condensed porcine solubles, condensed distillery solubles, molasses, desugared molasses, sugar syrup, lignan sulfonate, and condensed liquid whey.

In the present invention, the pellets may discharge from the pellet extruder die at a temperature of 100 to 150 degrees F., usually below 135 degree F., depending upon the diet formula, In a conventional pelleting processes, the pellets may have temperatures of 160 to 200 degree F. The low temperatures of the pellets of the present invention provide an opportunity to incorporate heat sensitive and labile substances such as enzymes, microbials, and milk proteins which can be destroyed and/or rendered nutritionally unavailable by heat in conventional pelleting processes.

The following examples illustrate practical embodiments of the invention.

### EXAMPLE 1

The liquid holding capacity of peanut shell fiber was tested in comparison to fibers derived from soybeans or corn. The purpose of the investigation was to determine whether peanut shell fiber could have favorable properties compared with other feedstocks commonly used in liquid-dry mixtures intended for pelleting. A high capacity to absorb liquids would be a desirable characteristic. The following graph shows the ability of peanut fiber to absorb liquids compared to other feedstocks.

### EXAMPLE 2

Food pellets containing peanut feedstocks were produced. The ingredient composition of pellets and the chemical composition of ingredient and pellets are presented in Table 1. A 30 hp Wenger Pellet Mill was used for manufacturing trials. Conditions of pellet production are shown in Table 2. The physical characteristics of ingredients and pellets are presented in Table 3. After manufacture, the pellets were stored under ambient conditions for varying periods of time to measure stability. These data also are presented in Table 3.

The investigation revealed that conventional mixing and pelleting equipment can be used to pelletize peanut co-streams without using steam during the pelleting process. Pelletized co-streams exhibited improved bulk density similar to ground peanut fiber. Adding pellet binder (Ameribond 2x) to the liquid-dry mix before pelleting did not improve durability of pellets as evidenced by similar durability indexes for pellets whether pellet binder was used or not used.

Peanut co-stream blends had ˜40% better dry matter digestibility and improved fiber digestibility compared with pelleted peanut fiber. Greater protein and fat content and better dry matter and fiber digestibility are benefits for pelletized co-streams compared with pelleted peanut fiber alone. The improvement in estimated digestibility of the food pellets over peanut fiber alone would enable better nourishment of animals.

Pellets containing raw soapstock at 5 to 7% (dry weight basis) of the formula appeared stable during post-manufacture storage whereas a higher amount of added soapstock increased moisture content resulting in unstable and moldy pellets. Raw soapstock exhibited a noxious rank odor but pelletizing soapstock with dry feedstock resulted in a non-descript odor profile for pellets. A high intensity caramel flavor did not improve odor or sensory characteristics of pellets and was perceived as a negative by select sensory panelists. Mixing liquid soapstock into a highly absorptive dry feedstock followed by pelleting resulted in stabilizing the soapstock and lessening the odors associated with decomposition and loss of soapstock value as a food for animals. The acid treatment of pellets resulted in better stability, with no evidence of molding after 8 weeks of storage.

The results of this investigation demonstrated that peanut co-streams are amenable to pelletizing using conventional feed manufacturing equipment. The surprising discovery was that durable and stable pellets could be manufactured without using steam conditioning of the mash. Furthermore, the application of a pellet binder was unnecessary. The stability, bulk density, and nutritional characteristics and potential feed value of peanut feedstocks were improved by mixing and pelleting.

TABLE 1
Characteristics of feedstocks and pelleted liquid-dry mixtures

| | Peanut | | | | | | | | | |
|---|---|---|---|---|---|---|---|---|---|---|
| Ingredient, | Hulls | Peanut | Peanut | BDB | BDB | BDB | BDB | BDB | BDB | BDB |
| % of dry weight | (ground) | soapstock | Meal | 1970 | 1971 | 1972 | 1973 | 1974 | 1980 | 1985 |
| Peanut fiber (ground) | | | | 85 | 88 | 84 | 83 | 82.95 | 88 | 88 |
| Peanut soapstock | | | | 10 | 7 | 10 | 10 | 10 | 5 | 5 |
| Peanut meal | | | | 5 | 5 | 5 | 5 | 5 | 5 | 5 |
| Ameribond 2x | | | | | | 1.0 | 1.0 | 1.0 | 1.09 | 1.08 |
| Caramel flavor | | | | | | | | 0.05 | | |
| Sodium propionate | | | | | | | 1.0 | 1.0 | | 1.08 |
| Sulfuric acid (conc.) | | | | | | | | | | 0.54 |
| Sodium hydroxide (50%) | | | | | | | | | 1.11 | |
| Total | | | | 100 | 100 | 100 | 100 | 100 | 100 | 100 |
| Nutrients, dry weight basis | | | | | | | | | | |
| % Moisture | 6.5 | 70.3 | 9.2 | 13.3 | 11.5 | 14.4 | 14.7 | 14.8 | 12.2 | 12.5 |
| % Dry matter | 93.5 | 29.7 | 90.8 | 86.7 | 88.5 | 85.6 | 85.3 | 85.2 | 87.8 | 87.5 |
| % Crude protein | 9.2 | 5.4 | 57.1 | 12.2 | 11.6 | 11.8 | 11.6 | 11.7 | 12.2 | 12.6 |
| % Acid detergent fiber | 58.2 | | 12.2 | 53.0 | 58.8 | 56.1 | 57.1 | 53.3 | 62.4 | 55.5 |
| % Neutral detergent fiber | 72.5 | | 20.4 | 64.2 | 64.9 | 63.6 | 62.1 | 63.3 | 69.3 | 70.4 |
| % Lignin | 25.4 | | 3.2 | 23.1 | 26.6 | 23.9 | 24.6 | 23.1 | 26.3 | 23.1 |
| % non-fiber carbohydrates | 10.6 | | 15.1 | 10.6 | 12.1 | 11.3 | 12.8 | 11.6 | 6.5 | 4.8 |
| % Crude Fat | 4.2 | 87.9 | 1.4 | 9.3 | 7.6 | 9.3 | 9.2 | 9.1 | 6.6 | 7.3 |
| % Ash | 3.5 | 9.7 | 6.0 | 3.8 | 3.8 | 3.9 | 4.3 | 4.3 | 5.34 | 4.86 |
| % Calcium | 0.17 | 0.05 | 0.12 | 0.16 | 0.16 | 0.22 | 0.22 | 0.23 | 0.26 | 0.25 |
| % Phosphorus | 0.09 | 0.28 | 0.76 | 0.15 | 0.13 | 0.14 | 0.14 | 0.15 | 0.16 | 0.15 |
| % Magnesium | 0.09 | 0.07 | 0.35 | 0.10 | 0.10 | 0.10 | 0.10 | 0.11 | 0.12 | 0.11 |
| % Potassium | 0.66 | 0.30 | 1.41 | 0.69 | 0.68 | 0.68 | 0.69 | 0.74 | 0.79 | 0.74 |
| % Sodium | 0.01 | 3.69 | 0.01 | 0.27 | 0.18 | 0.27 | 0.48 | 0.52 | 0.82 | 0.45 |
| PPM Iron | 530 | 238 | 355 | 505 | 497 | 506 | 532 | 527 | 585 | 560 |
| PPM Zinc | 14 | 16 | 65 | 19 | 18 | 18 | 19 | 20 | 24 | 20 |
| PPM Copper | 11 | 2 | 14 | 12 | 11 | 11 | 11 | 12 | 23 | 14 |
| PPM Manganese | 48 | 14 | 37 | 46 | 46 | 50 | 50 | 53 | 64 | 56 |
| PPM Molydenum | 0.4 | 0.5 | 1.9 | 0.2 | 0.7 | 0.5 | 0.6 | 0.6 | 0.2 | 0.2 |
| % Sulfur | 0.09 | 0.04 | 0.39 | 0.10 | 0.10 | 0.14 | 0.14 | 0.15 | 0.18 | 0.37 |
| *IVTD 48 hr, % of DM | 36 | | 95 | 42 | 43 | 47 | 47 | 45 | 44 | 48 |
| *NDFD 48 hr, % of NDF | 12 | | 75 | 10 | 13 | 17 | 15 | 12 | 19 | 25 |
| pH at manufacture | 5.06 | 6.50 | 5.68 | 6.09 | 5.85 | 6.00 | 6.04 | 5.85 | 11.40 | 4.78 |
| pH at 2 weeks | | | | 5.57 | 6.42 | 6.25 | 6.43 | 6.42 | | |
| pH at 4 weeks | | | | | | | | | | 5.14 |
| Condition at 2 weeks | | | | moldy | stable | moldy | stable | stable | | |
| Condition at 4 weeks | | | | moldy | stable | moldy | stable | stable | stable | stable |
| Condition at 8 weeks | | | | | | | | | moldy | stable |

*IVTD = in vitro true digestion of dry matter, corrected for control, when samples were incubated in buffered rumen fluid for 48 hours
NDFD = neutral detergent fiber digestion when samples were incubate din buffered rumen fluid for 48 hours

TABLE 2
Processing conditions used to pelletize feedstocks

| | | | | Initial | | |
|---|---|---|---|---|---|---|
| | Pellet | | | Mash | Hot Mash | Hot Pellet |
| Formula | Size | Steam | Amps | Temp ° F. | Temp ° F. | Temp ° F. |
| BDB 1970 (1) | 5/16 | 0 | 16 | 70 | | 102 |
| BDB 1971 (2) | 5/16 | 0 | 17 | 76 | | 110 |
| BDB 1972 (3) | 5/16 | 0 | 17 | 79 | | 104 |
| BDB 1973 (4) | 5/16 | 0 | 17 | 79 | | 104 |
| BDB 1974 (4) | 5/16 | 0 | 10 | 79 | 142 | 140 |

TABLE 3
Physical characteristics of pelletized feedstocks

| | Angle of | | | | | | | | PDI | Bulk | % |
|---|---|---|---|---|---|---|---|---|---|---|---|
| Item | Repose | 50 | 45 | 40 | 35 | 30 | 25 | PDI | w/nuts | Density lb/ft3 | Fines |
| Peanut Hulls | 36 | 0 | 0 | 0 | 0 | 0 | 0 | | | 30.3 | |
| (ground) | | | | | | | | | | | |
| Peanut Meal | 33 | 0 | 0 | 0 | 0 | 0 | 0 | | | 44.2 | |
| BDB 1970 (1) | 39 | 0 | 0 | 0 | 1 | 2 | 4 | 90 | 3 | 32.7 | 4.1 |
| BDB 1971 (2) | 38 | 0 | 0 | 0 | 0 | 2 | 2 | 86 | 4 | 34.2 | 3.0 |
| BDB 1972 (3) | 40 | 0 | 0 | 0 | 0 | 1 | 3 | 91 | 5 | 34.1 | 3.0 |
| BDB 1973 (4) | 40 | 0 | 0 | 0 | 0 | 3 | 5 | 93 | 6 | 34.9 | 2.2 |
| BDB 1974 (4) | 40 | 0 | 0 | 1 | 2 | 3 | 7 | 94 | 4 | 34.0 | 3.0 |

### EXAMPLE 3

The purpose of this study was to evaluate feed consumption by cattle offered a pelleted food comprised of predominantly peanut feedstuffs compared with consumption of a conventional pellet containing corn and agricultural processing coproducts.

Six cattle averaging 264 kg in body weight were maintained in an open lot pen and offered pelleted feeds using an electronic feeding system that permitted recording of individual animal feed consumption on a daily basis. Animals were fitted with permanent rumen cannulas that enabled the collection of rumen fluid during the study.

A conventional feed pellet comprised of corn and coproducts was offered in period one and a prototype pellet comprised of peanut co-products was offered during period two. The length of each period was 7 days. Animals were adjusted during a transition period lasting four days to the prototype peanut pellet. The pellets were offered to appetite and unconsumed feed was collected each day and recorded. Consumption of feed pellets was recorded over a 7-day period and an average amount of pellet dry weight was estimated for each animal. The animals also were offered chopped orchard grass-fescue grass (9% protein, 70% neutral detergent fiber) to appetite. Consumption of chopped forage was not recorded during the study. Rumen fluid was collected at 3 time points on the final day of feeding during period two.

The composition of the conventional feed pellet and peanut pellet is presented in Table 4. The conventional pellet was formulated to contain a greater amount of protein and digestible energy compared with the prototype pellet. The peanut pellet contained a considerably greater amount of fiber compared with the conventional pellet. With the exception of one animal, cattle consumed the peanut pellet in greater amounts compared with the conventional pellet (FIG. 2). These results showed that the peanut pellet was palatable and provided nourishment for the animals. The rumen pH of animals when fed the peanut pellet are presented in Table 5. The measured pH for rumen fluid was within normal range (pH 6 to 7) for cattle consuming high fiber diets, indicating that the peanut pellet contributed to normal conditions for digestion of nutrients in the rumen.

Peanut coproducts can be mixed and formed into pelleted feeds that are readily consumed by animals such as cattle. Cattle exhibited normal consumption patterns and rumen fermentation. The pelleted peanut feed can substitute traditional coproducts as nourishment for animals, particularly ruminant animals.

TABLE 4
Ingredient Composition and Nutritional Profile of Feed Pellets

| | Conventional pellet | Peanut pellet |
|---|---|---|
| Ingredient, % as fed | | |
| Ground corn | 48.6 | |
| Wheat middlings | 17.7 | |
| Corn gluten feed | 15.0 | |
| Distillers dried grains | 9.9 | |
| Arsoy soybean fiber | 5.3 | |
| Molasses (cane) | 2.0 | |
| Minerals, vitamins, additives | 1.5 | |
| Peanut fiber (milled) | | 81.7 |
| Vegetable oil refinery liquid | | 10.0 |
| Peanut meal | | 7.5 |
| Sodium propionate | | .75 |
| Chemical Composition (as fed) | | |
| Moisture | 12.2 | 10.2 |
| Dry matter, % | 87.8 | 89.8 |
| Protein, % (N × 6.25) | 14.0 | 11.1 |
| Acid detergent fiber, % | 7.0 | 47.6 |
| Neutral detergent fiber, % | 18.5 | 57.7 |
| Calcium, % | .41 | .21 |
| Phosphorus, % | .55 | .17 |
| Magnesium, % | .23 | .12 |
| Potassium, % | .75 | .76 |
| Sodium, % | .23 | .30 |
| Sulfur, % | .25 | .13 |
| Iron, ppm | 16.0 | 302 |
| Zinc, ppm | 45.6 | 39 |
| Copper, ppm | 11.4 | 12 |
| Manganese, ppm | 45.6 | 53 |
| Molybdenum, ppm | n.m. | 0.2 |
| Estimated NEM, Mcal/lb | .84 | .68 |
| Estimated NEG, Mcal/lb | .56 | .41 |
| Pellet Characteristics | | |
| pH | | 5.58 |
| Bulk density, lb/ft³ | | 27.5 |

TABLE 5
Rumen pH of animals

| Time of Day | Animal # | Rumen fluid pH |
|---|---|---|
| 0600 | 424 | 6.47 |
| | 426 | 6.81 |
| | 428 | 6.36 |
| | 466 | 6.82 |
| | 482 | 6.29 |
| 0930 | 424 | 6.18 |
| | 426 | 6.35 |
| | 428 | 6.28 |
| | 466 | 6.59 |
| | 482 | 6.42 |
| 1230 | 424 | 6.16 |
| | 426 | 6.63 |
| | 428 | 6.29 |
| | 466 | 6.82 |
| | 482 | 6.19 |

What is claimed is:

1. A method of making ready-to-consume animal feed pellets without using steam conditioning or pellet binder, the method comprising:
forming a uniform mixture of a solid peanut ingredient and a liquid peanut ingredient; and
passing the uniform mixture through a pellet mill having a roller and die extruder, thus forming pellets;
wherein the method does not subject the uniform mixture to steam conditioning.

2. The method according to claim 1, further comprising cooling the pellets.

3. The method according to claim 1, further comprising drying the pellets.

4. Animal food pellets made according to the method of claim 1.

5. The method according to claim 1, wherein the liquid peanut ingredient has viscous and cohesive properties.

6. The method according to claim 1, wherein the liquid peanut ingredient and the solid peanut ingredient includes at least one labile feed ingredient.

7. The method according to claim 1, wherein a temperature of the pellet in the pellet mill does not exceed 150 degrees F.

8. The method according to claim 1, further comprising removing fine particles from the pellets.

9. The method according to claim 8, further comprising mixing the fine particles with the uniform mixture.

10. The method according to claim 1, wherein the solid peanut ingredient is selected from the group consisting of peanut meal, peanut hulls, and a combination thereof, and the liquid peanut ingredient comprises peanut soapstock.

11. A method of producing a pellet, the method comprising:
mixing a liquid peanut coproduct with a solid peanut coproduct, thus producing a mixture; and
compressing the mixture, thus producing a pellet.

12. The method according to claim 11, wherein the liquid peanut coproduct is peanut soapstock.

13. The method according to claim 11, wherein the liquid peanut coproduct is present in the pellet at an amount of 1-10% by weight, 3-8% by weight, or 5-7% by weight.

14. The method according to claim 11, wherein the solid peanut coproduct is selected from the group consisting of peanut meal, peanut hulls, and a combination thereof.

15. The method according to claim 11, further comprising mixing a pelleting agent with the mixture.

16. The method according to claim 11, further comprising mixing an acidifier with the mixture.

17. The method according to claim 16, wherein the acidifier is present in such an amount to stabilize the pellet.

18. The method according to claim 16, wherein the acidifier is sodium propionate.

19. The method according to claim 11, further comprising removing fine particles from the pellets.

20. The method according to claim 19, further comprising mixing the fine particles with the uniform mixture.
